(19) United States
(12) Patent Application Publication
(10) Pub. No.: US 2008/0255988 A1
(43) Pub. Date: Oct. 16, 2008

(54) INTERACTIVE MEMORIALS

(75) Inventor: Michele A. Maltese, Dearborn, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: IntelliGlimpse LLC

(21) Appl. No.: 12/102,804

(22) Filed: Apr. 14, 2008

Related U.S. Application Data
(60) Provisional application No. 60/923,500, filed on Apr. 13, 2007.

(51) Int. Cl. G06Q 40/00

(52) U.S. Cl. 705/39; 705/1; 707/10

(57) ABSTRACT

A memorial center is configured to receive a notification, where the notification includes identification information. The memorial center is further configured to authenticate the identification information contained in the notification, thereby creating authenticated data. The memorial center is further configured to receive a request to provide the authenticated data to a designee, and further configured to provide the authenticated data to the designee.

### CROSS REFERENCE TO RELATED APPLICATION

This application claims the benefit of co-pending U.S. provisional patent application Ser. No. 60/923,500 (entitled “SYSTEM AND METHOD FOR AUTHORING MULTIMEDIA WEBSITE”), filed on Apr. 13, 2007, and hereby incorporated by reference in its entirety.

### BACKGROUND

People often mourn the passing of a friend, family member, or pet in many different ways. Funerals, wakes, burials, and cremations are just a few of the many ways in which people cope with such a loss. Such events often take place in accordance with various religious and cultural traditions. Unfortunately, friends and family may live far away and be unable to participate in such events. To further complicate matters, many people may wish to mourn the deceased, or celebrate their life, in significantly different ways. For example, a person may request cremation, while their family may desire a fixed location, such as a burial plot, to go and reminisce about their loved one.

### BRIEF DESCRIPTION OF THE DRAWINGS

FIG. 1 illustrates an exemplary system for managing interactive memorials.

FIG. 2 illustrates an exemplary process for establishing relationships.

FIG. 3 illustrates an exemplary process for providing authenticated data to a memorial center.

FIG. 4 illustrates an exemplary process for providing authenticated data to a designee.

FIG. 5 illustrates an exemplary process for verifying data.

FIG. 6 illustrates an exemplary process for interacting with a memorial center.

FIG. 7 illustrates an exemplary process for creating and managing an interactive memorial.

### DETAILED DESCRIPTION

### System for Managing Interactive Memorials

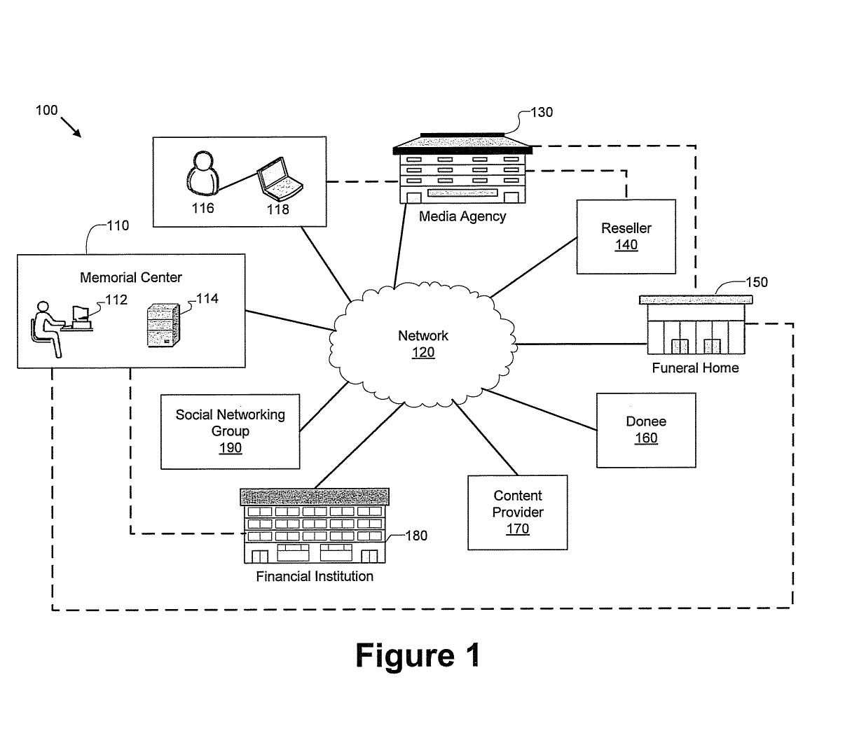

FIG. 1 illustrates an exemplary system 100 for managing interactive memorials. An interactive memorial is generally an interactive website that is dedicated to the memory of a deceased person. While such interactive memorials are described below with regards to deceased persons, it should be understood that such interactive memorials can also be used with deceased pets as well. An interactive memorial is typically an on-line or web-based interactive multimedia website that can include one or more of the following: a guest book; a digital library of photos, videos, or the like; a timeline remembering the deceased; an animated introduction; links to living or deceased friends or family members; links to one or more donees; information about funeral or memorial services; a link to a media agency; an advertisement; information about a content provider; or any number of additional features, as described below.

System 100 provides multiple services, including providing interactive memorials, facilitating the creation of such interactive memorials, facilitating the collection and transfer of authenticated information about a recently departed person, and connecting friends and family members of a recently deceased person with a donee. System 100 typically includes a memorial center 110, a user 116, a network 120, and a media agency 130. System 100 can also include a reseller 140, a funeral home 150, a donee 160, a content provider 170, a financial institution 180, and a social networking group 190.

Memorial center 110 communicates with various entities within system 100, and manages interactive memorials, as will be discussed in greater detail below. Memorial center 110 can also market, advertise, and create relationships with one or more entities within system 100 for various purposes. Typically, memorial center 110 includes personnel and computing equipment for carrying out some or all of the operations that are described below with respect to the various processes. Memorial center 110 generally includes personnel, and various computing and communications equipment, including an operator 112, and a server 114. Operator 112 is generally a person with access to various internal computing systems and databases, and can assist a user 116 to use and manage various services provided by memorial center 110, including creating an interactive memorial.

Server 114 generally includes a computer-readable medium, a processor, a memory, and a database. Server 114 can be a single device or a plurality of devices such as individual and distinct computing systems, each system comprising a portion of server 114. Server 114 may also provide one or more databases for storing, retrieving, and analyzing one or more pieces of data. Further, server 114 typically provides an interactive mechanism for a user 116 to access and manage various features of an interactive memorial. In an illustrative example, the interactive mechanism is a website that is accessible by a user 116 via network 120. When a website is used as the interactive mechanism, user 116 typically uses a terminal 118 to access various websites, including websites provided by server 114. For example, terminal 118 can communicate with server 114 through network 120.

Network 120 is typically a combination of packet networks, such as the Internet. Network 120 can also be and/or include a local area network (LAN), a wide area network (WAN), a wireless network, a cellular network, or the like. Network 120 can connect computing devices, such as terminal 118, to memorial center 110. More specifically, network 120 typically enables such computing devices, such as terminal 118, to communicate with server 114. Typically, user 116 uses terminal 118 to interact with server 114, as well as other entities configured to communicate via network 120. Terminal 118 is generally any computing device capable of communicating with server 114 over network 120. For example, terminal 118 can be any of a number of different computing devices, including a desktop computer, a laptop computer, a tablet computer, a personal digital assistance (PDA), a cellular telephone, or the like. Furthermore, network 120 can facilitate communication between additional entities of system 100 and memorial center 110, such as media agency 130.

Additionally, as shown in FIG. 1, certain entities can and often do communicate with one another via network 120, as well as via additional mechanisms. For example, as denoted by dashed lines in FIG. 1, certain entities often communicate via courier, telephone, fax, postal mail, or using additional mechanisms that do not necessarily involve network 120. While some of these additional routes of communication are shown, it should be apparent that each entity shown in FIG. 1 is capable of multiple routes and mechanisms of communication and is in no way limited to network 120.

Media agency 130 is typically a media outlet that provides notice of recently deceased persons. For example, media agency 130 can provide obituaries, tributes, notices, or the like to inform others that a person has recently passed on. Media agency 130 can be a website, a newspaper, a magazine, a television station, a cable network, or the like. In one example, media agency 130 is a print newspaper that also provides an on-line version of its content. For example, media agency 130 can be a local newspaper that is dedicated to a local region, such as a state, city, county, township, or the like. In another example, media agency 130 is a local television station that also provides a website that includes notices of recently departed persons. In yet another example, media agency 130 is a specialty publication dedicated to a group of people that share a particular religion, culture, demographic, ethnicity, background, homeland, or some other common factor.

System 100 may also include a reseller 140. Reseller 140 can be any entity or individual that makes an arrangement with memorial center 110 to promote one or more of the various services offered by memorial center 110. For example, reseller 140 may be an individual that engages in various advertising activities on behalf of memorial center 110. Reseller 140 may also be a furnisher of funeral services, a funeral home, a mortuary, a newspaper, a church, a charity, or any other organization that can establish a relationship with memorial center 110. For example, memorial center 110 may offer a standard reseller relationship, where reseller 140 and memorial center 110 agree to particular terms. For example, memorial center 110 may agree to provide reseller 140 a percentage of any proceeds generated from a referral. In return, reseller 140 may agree to certain terms and conditions, such as agreeing to promote the services of memorial center 110 above any potentially competing organization.

System 100 may also include a funeral home 150. Funeral home 150 can be one or more organizations that provide good and/or services related to the passing of an individual. In one example, funeral home 150 is an organization that handles the remains of a recently deceased person, and also arranges services in accordance with the wishes of the family and/or of the deceased. For example, funeral home 150 can handle the necessary paperwork, permits, and other details. As another example, funeral home 150 can provide information and/or an obituary to media agency 130. In addition, funeral home 150 can make arrangements with a donee 160.

Donee 160 may be a charitable organization selected by a decedent's family. For example, many families select a particular charity and request donations to that charity to honor a recently deceased loved one. Donee 160 can also include an investment account, an education fund, a retirement account, or the like. Donee 160 can also be an individual or organization that directly or indirectly provides assistance to the dependants or family of a recently deceased person. In general, donee 160 can be any person or entity that is selected to receive donations in honor of a recently deceased person. For example, a recently deceased person may have been afflicted by a particular type of cancer, and the family of that recently deceased person may request donations to a particular cancer research institute in that person's honor. While such donations are typically money, other donations may include food, clothing, living supplies, school supplies, stocks, bonds, or anything else that can be used to benefit another person or organization.

System 100 may also include a content provider 170. Content provider 170 may be any person or entity that is capable and willing to provide multimedia content to be used by memorial center 110 in an interactive memorial. For example, content provider 170 may be a musician that provides music to be used in an interactive memorial. In another example, content provider 170 is a web developer that creates web page templates for use in an interactive memorial. In another example, content provider 170 is an artist that provides digital artwork, photographs, and website decorations for use in an interactive memorial.

System 100 may also include a financial institution 180. Financial institution 180 typically facilitates the transfer of money between various entities within system 100. For example, financial institution can be involved in one or more of the following activities: authorizing purchases; debiting charge card accounts; and tracking charge card account activity. Financial institution 180 can be any number of different institutions, including a bank, a credit union, a non-profit, or some other entity. For example, financial institution 180 can be a bank that allows one entity to accept a credit card payment from another entity. In another example, financial institution is an on-line or e-commerce institution that facilitates money transfers. For example, memorial center 110 may require payment for certain services, and financial institution 180 may facilitate such payments. In addition, financial institution 180 can also help a user 116 give a donation to donee 160.

System 100 may also include a social networking group 190. Typically, social networking group 190 is an online social network for communities of people to interact and communicate with one another. Social networking group 190 can be a website dedicated to social networking, such as MySpace® and FaceBook®. Social networking group 190 typically includes computing hardware and software to communicate with server 114 through network 120.

### Establishing Relationships

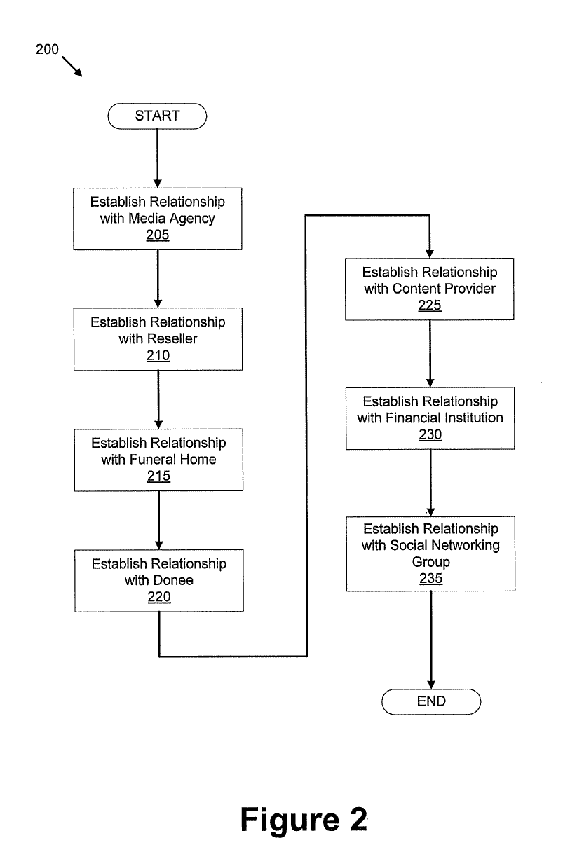

FIG. 2 illustrates an exemplary process 200 for establishing relationships between memorial center 110 and various entities within system 100. Process 200 begins in step 205 when memorial center 110 establishes a relationship with a media agency 130. Typically, a representative of memorial center 110 contacts media agency 130 to identify a contact person. Such a contact person is typically involved with obituaries, or notices of recently deceased individuals. Memorial center 110 may establish a relationship where media agency 130 agrees to provide a link to memorial center 110 on any website dealing with obituaries. For example, media agency 130 may be a newspaper that also maintains a website for news content. Media agency 130 may agree to include a link to memorial center 110 in every obituary posted on-line. Memorial center 110 may in turn agree to remit a percentage of any proceeds generated via such links back to media agency 130. In addition, as discussed in more detail below, memorial center 110 and media agency 130 may also establish certain procedures for sharing authenticated information about a recently deceased person.

Next, in step 210, memorial center 110 establishes a relationship with a reseller 140. Typically, a person or representative of an organization contacts memorial center 110 and asks to form a reseller agreement. Memorial center 110 may provide a standard reseller contract on a website, where such a contract clearly defines the benefits and responsibilities of all parties involved in a reseller arrangement. For example, memorial center 110 may agree to remit a percentage of proceeds to a reseller 140 for every referral that generates such proceeds. Memorial center 110 may also create a tiered system, where W number of referrals entitles a reseller to X percentage of proceeds, and Y number of referrals entitles a reseller to Z percentage of proceeds. Memorial center 110 may also establish individualized agreements that include reciprocal advertising and other benefits between memorial center 110 and reseller 140.

Next, in step 215, memorial center 110 establishes a relationship with a funeral home 150. Memorial center 110 may offer various incentives to a funeral home 150 to establish a mutual beneficial relationship. For example, memorial center 110 may request that funeral home 150 become a reseller 140, as described above with reference to step 210. In exchange, memorial center 110 may provide advertising for funeral home 150. Memorial center 110 may be capable of providing one or more types of advertising systems. For example, memorial center may insert a web-based advertisement, such as a banner advertisement, on each interactive memorial. In one example, memorial center 110 provides such an advertisement for funeral home 150 on each interactive memorial that funeral home 150 referred to memorial center 110. In another example, memorial center 110 may provide an advertisement on every interactive memorial associated with a particular geographic location. In another example, memorial center 110 may provide such an advertisement based on an estimated location of a user 116. For example, memorial center 110 may employ one or more various techniques to estimate the location of a user 116 that visits an interactive memorial, and then provide an advertisement to a local business, such as funeral home 150, based on that location estimation.

Next, in step 220, memorial center 110 establishes a relationship with a donee 160. Memorial center 110 may establish relationships with several popular donees 160, such as various cancer research foundations or popular charities. Memorial center 110 may also establish relationships with a donee 160 after a decedent's family has requested to make donations to a particular donee 160. Typically, such a relationship may involve an agreement where memorial center 110 facilitates all donations made in honor of a particular recently deceased person, and donee 160 agrees to provide a notice, or subtle advertisement, that memorial center 110 provided such a service.

Next, in step 225, memorial center 110 establishes a relationship with a content provider 170. Memorial center 110 may recruit several content providers 170, while others may desire to work with memorial center 110. For example, a new musician that is trying to create publicity may provide music to memorial center 110 for use in interactive memorials. In exchange, memorial center 110 may provide advertisement or proper attribution to the musician on each interactive memorial that uses the provided music. In other examples, artists and web developers may also desire name recognition, or simply provide a commercial example of their work, and in exchange for such content, memorial center 110 can provide attribution or subtle advertisement for content provider 170.

Next, in step 230, memorial center 110 establishes a relationship with a financial institution 180. Typically, memorial center 110 contracts with one or more financial institutions 180 to facilitate payments to memorial center 110 for services, such as payments from user 116, funeral home 150, or the like. In addition, memorial center 110 may establish a relationship such that financial institution 180 facilitates the transfer of donations from a user 116 to a donee 160 through memorial center 110.

Next, in step 235, memorial center 110 establishes a relationship with a social networking group 190. Such a relationship may entail cross-linking sites, providing a portal to view an interactive memorial from a social networking website, or providing a portal to view content from a social networking site through memorial center 110. Following step 235, process 200 ends.

### Providing Authenticated Data to a Memorial Center

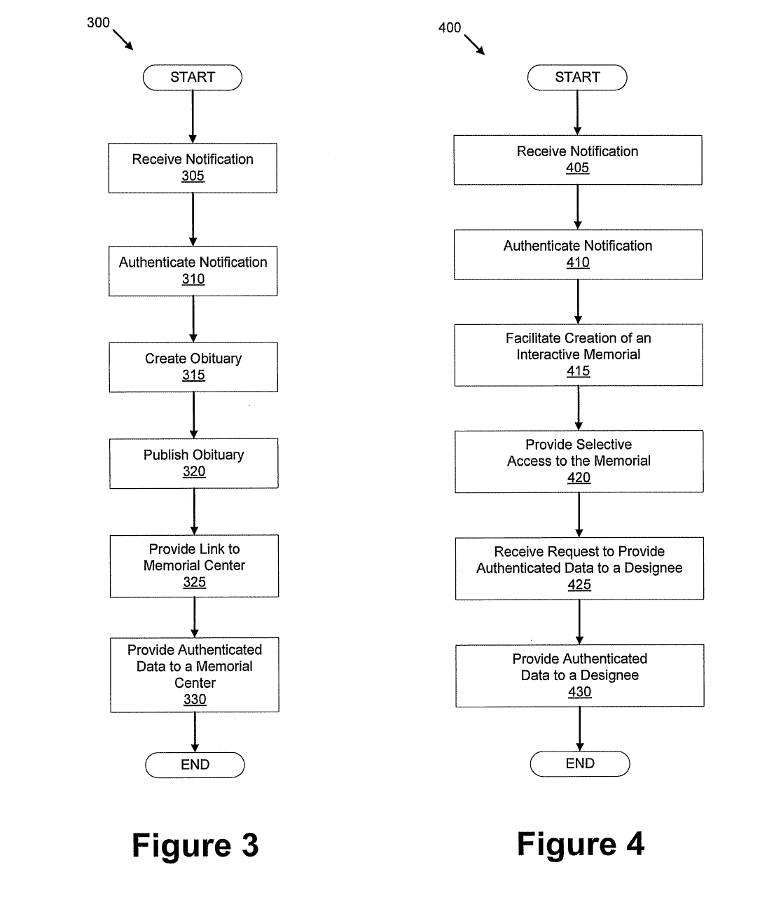

FIG. 3 illustrates an exemplary process 300 for providing authenticated data to memorial center 110. Process 300 begins in step 305 by receiving a notification that a person has passed away. Such a notification may be received by a number of different entities within system 100. For example, media agency 130 may receive such notification from a person's family, from a funeral home, etc. Typically, such a notification includes pertinent information about the recently deceased person, such as a name, date of birth, date of death, funeral information, etc. Of course, such a notification may be received by local police, by a hospital, by a funeral home, or the like.

Next, in step 310, the data contained in the notification is authenticated. For example, a fact checking personnel at a media agency 130 may request additional info to authenticate that the information provided in the notification is genuine and authentic. By authenticating such information, mistakes are prevented and fraud or pranks are avoided. For example, media agency 130 or funeral home 150 may request a copy of a government or other document verifying such information, such as a death certificate.

Next, in step 315, an obituary is created. Typically, an obituary is created by media agency 130, but may also be created by any number of different entities involved in system 100. For example, a religious official may draft an obituary and provide the writing to media agency 130, funeral home 150, or the like. An obituary may also be written by the family of the deceased person, by funeral home 150, etc.

Next, in step 320, the obituary is published. Oftentimes, media agency 130 publishes the obituary. Such a publication may occur in a print newspaper, on a website, through a television newscast, or the like. In one example, media agency 130 is a local newspaper that also provides a website version of content, including obituaries. Media agency 130 then published the obituary in both a print newspaper, and online through such a website.

Next, in step 325, a link to memorial center is provided. Typically, the link is an Internet hyperlink provided by media agency 130. Such a link may be a general link, such as a web-based banner advertisement, or may be a specific link associated with an individual's on-line obituary. For example, an on-line obituary may include pertinent information about a recently deceased person, and may also include a link that states “Create a Memorial” and links to memorial center 110. In another example, funeral home 150 provides such a website that includes descriptions of recently deceased persons, and also includes a link to memorial center 110 associated with each recently deceased person.

Next, in step 330, the authenticated data about the recently deceased person is provided to memorial center 110. For example, a user 116 views the on-line obituary and selects the “Create a Memorial” link. In response, the authenticated data is automatically send to memorial center 110, and user 116 is requested to start creating an interactive memorial for the recently deceased person. Following step 330, process 300 ends.

### Providing Authenticated Data to a Designee

FIG. 4 illustrates an exemplary process 400 for providing authenticated data to a designee. Process 400 begins in step 405 when a notification that a person has recently passed is received. As discussed above with respect to step 305 of process 300, such a notification can be received by any number of different entities associated with system 100. In one example, such a notification is received by memorial center 110.

Next, in step 410, the data contained within the notification is authenticated. Memorial center 110 may receive the notification, and then authenticate the notification by requesting additional info, such as a death certificate.

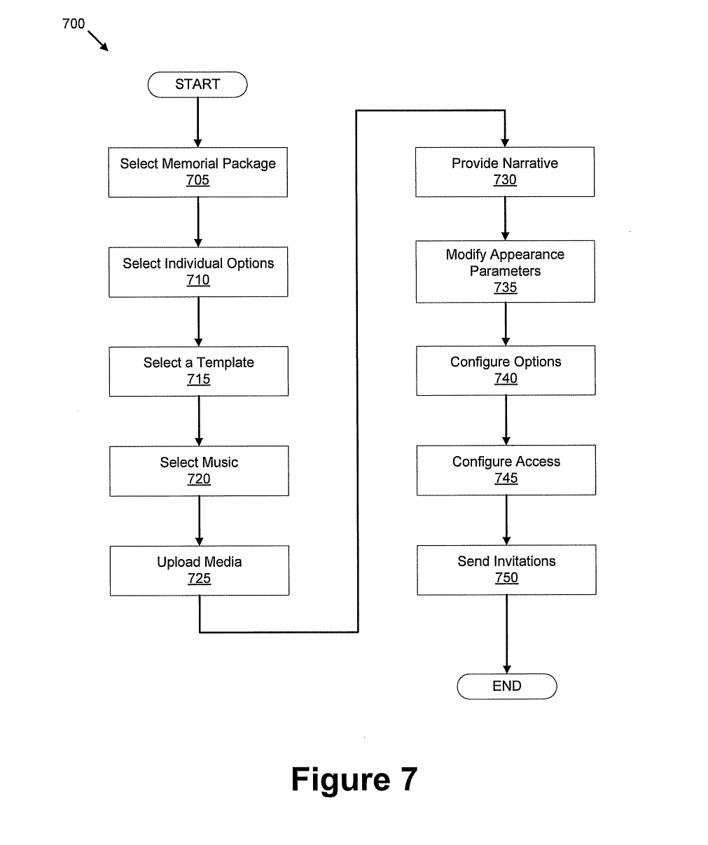

Next, in step 415, memorial center 110 facilitates the creation of an interactive memorial. Such a process is described in more detail below with respect to FIG. 7. Typically, memorial center 110 assists a user 116 to create an interactive memorial dedicated to the recently deceased person. Typically, such an interactive memorial includes pertinent information about the recently deceased person. Such information may include the person's name, age at death, date of birth, date of death, last residence, family information, funeral information, accomplishments, etc.

Next, in step 420, memorial center 110 provides selective access to the interactive memorial. For example, memorial center 110 may use various security measures to limit access to the interactive memorial. In another example, memorial center 110 simply provides access to the interactive memorial without restriction.

Next, in step 425, memorial center 110 receives a request to provide authenticated data to a designee. In one example, a relative that lives in a different community may desire to have a local media agency 130 publish an obituary or notification that the person has passed. In another example, a family member may request memorial center 110 to provide such authenticated data to a funeral home 150, a donee 160, a social networking group 190, or some other designee.

Next, in step 430, memorial center 110 provides the authenticated data to the designee. In some instances, it may be necessary to also provide a copy of any supporting documentation, such as a copy of a death certification or other proof, as well as the authenticated data. For example, a media agency 130 may require such accompanying documents. Memorial center 110 can provide the authenticated data as well as any supporting documentation to the designee. Such a service may relieve a grieving family of providing such information, including such supporting documentation, to multiple third parties. Following step 430, process 400 ends.

### Verifying Data

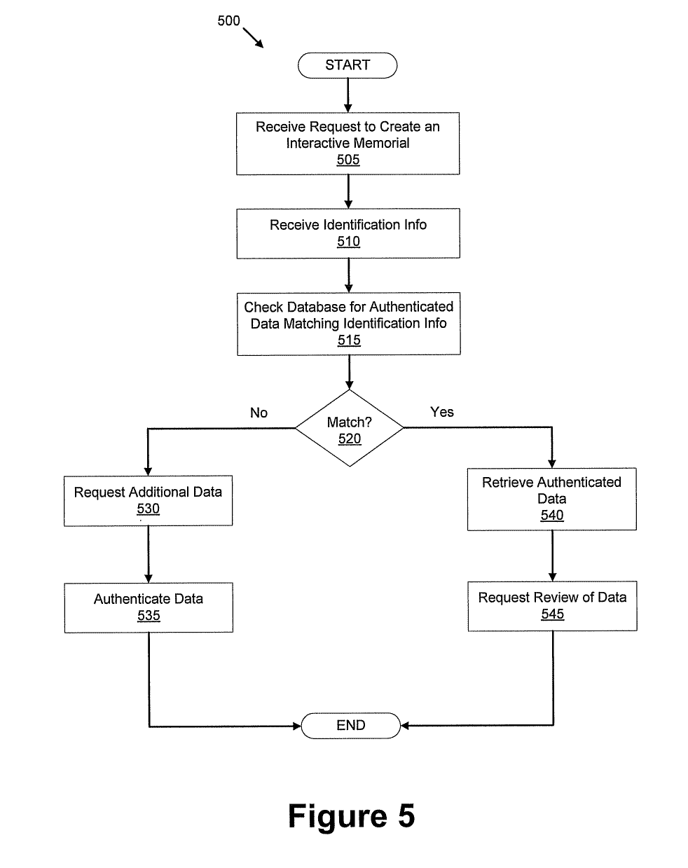

FIG. 5 illustrates an exemplary process 500 for verifying data. Process 500 begins in step 505 when memorial center 110 receives a request to create an interactive memorial. Typically, user 116 makes such a request through a website. In one example, user 116 access a website provided by server 114 through network 120 using terminal 118. In another example, user 116 selects a link, such as one provided by a media agency 130, that then directs user 116 to memorial center 110.

Next, in step 510, memorial center 110 receives identification info thereby identifying a deceased person. In one example, the identified person has been deceased for a long time and user 116 desires to create an interactive memorial dedicated to that person's memory. In another example, the identified person is recently deceased. The identification info can be provided by user 116 through a website provided by server 114. In another example, the identification info is provided by a designee, such as a media agency 130 or funeral home 150. In one example, a user 116 selects a link entitled “Create a Memorial” that is associated with an on-line obituary provided by media agency 130 or funeral home 150. After user 116 selects such a link, the identification information is provided to memorial center 110 from the website of media agency 130 or funeral home 150.

Next, in step 515, memorial center 110 checks a database for authenticated data matching the identification info. For example, memorial center 110 may have already received and authenticated the data associated with the identified deceased person. In another example, memorial center 110 may have already received authenticated data from another entity, such as media agency 130 or funeral home 150.

Next, in step 520, memorial center 110 determines if server 114 contains authenticated data matching the identification info provided in step 510. Server 114 may employ any number of different logic routines to make such a determination. For example, such a determination may be based on a last name and a zip code, a first and last name together, a similarity match, or any number of different combinations of comparing such data. If memorial center 110 determines that no match exists, then process 500 continues to step 530. If memorial center 110 determines that a match does exist, then process 500 continues to step 540.

In step 530, memorial center 110 informs user 116 that more information is required. Memorial center 110 may then request information relating to the deceased individual, such as a name, date of birth, date of death, etc.

Next, in step 535, memorial center 110 authenticated the received data, as described with respect to steps 310 and 410 of processes 300 and 400, respectively. For example, memorial center 110 may request a digital copy of supporting documentation, such as a death certificate. Following step 535, process 500 terminates.

In step 540, memorial center 110 retrieves the previously stored authenticated data from a database within server 114. User 116 may receive a message indicated that memorial center 110 already has the necessary information, and that such information has also been authenticated.

Next, in step 545, memorial center 110 may request that user 116 review the data. Such a review may also ensure that the retrieved data relates to the particular deceased individual that user 116 desires to create an interactive memorial honoring. Further, such a review may help to fix any potential typographical errors before such an interactive memorial is published, or before such data is provided to any third parties. Following step 545, process 500 ends.

Interacting with a Memorial Center

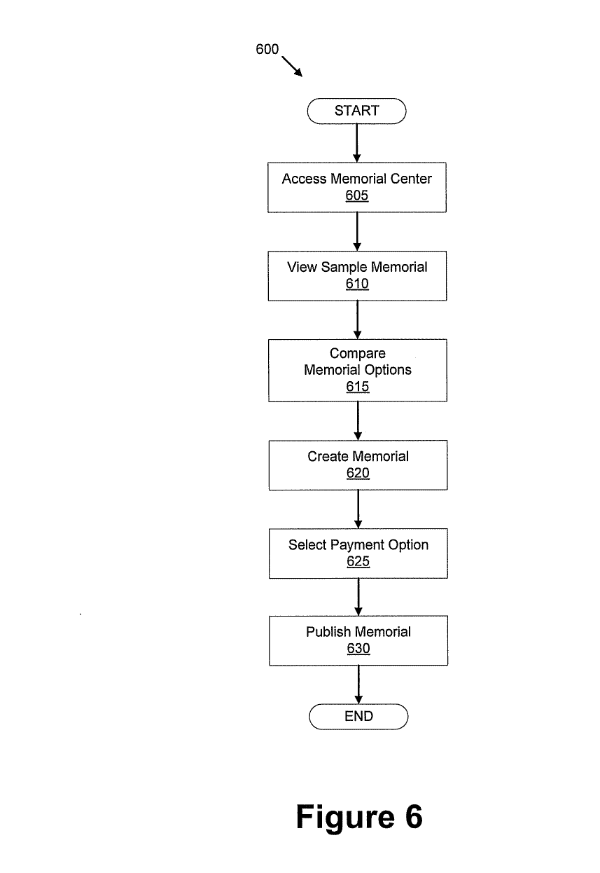

FIG. 6 illustrates an exemplary process 600 for interacting with memorial center 110. Process 600 begins in step 605 when a user 116 access a website provided by memorial center 110. For example, server 114 can provide an entrance website dedicated to new visitors. As described in greater detail below, such a website can be tailored to educate user 116 about services offered by memorial center 110, to guide user 116 through the process of creating an interactive memorial, and to help user 116 find an already established interactive memorial.

Next, in step 610, user 116 can view sample interactive memorials. Along with descriptions of interactive memorials, user 116 is able to browse through and use such samples to gain an understanding of an interactive memorial.

Next, in step 615, user 116 can compare options associated with an interactive memorial. In one example, memorial center 110 offers different option assortments, or packages, where each package has a different arrangement of options at a different price. Further, user 116 can research each individual option and understand the benefits offered and the costs associated with each.

Next, in step 620, user 116 can create an interactive memorial. In one example, user 116 is able to select a package of options, and create the entire interactive memorial without submitting any payment. This allows user 116 to determine if the package and/or the interactive memorial is appropriate.

Next, in step 625, user 116 can select a payment option. Memorial center 110 may have any number of different payment options that user 116 can select from. For example, memorial center 110 can request a time-based publication fee, thereby ensuring that the interactive memorial is published for a specific period of time. For example, memorial center 110 may require a fixed fee for a year of publication. In another example, memorial center 110 may provide interactive memorials for free and simply request that user 116 accept that certain advertisements may be presented in associated with the interactive memorial.

Next, in step 630, memorial center 110 published the interactive memorial on-line. Following step 630, process 600 ends.

### Creating and Managing an Interactive Memorial

FIG. 7 illustrates an exemplary process 700 for creating and managing an interactive memorial. Process 700 beings in step 705 when a user 116 selects an interactive memorial package. As described above, a package can be a combination of options associated with an interactive memorial.

Next, in step 710, user 116 can select additional, or alternative options to be associated with the interactive memorial. Such options may include a guestbook, a media library of digital photos and movies, an address book of friends and family, a timeline, a family tree, a family history, etc.

Next, in step 715, user 116 can select a template. A template can be a website template that includes a background, font, color scheme, border, buttons, etc. Memorial center 110 may provide any number of different types and styles of templates. In one example, memorial center 110 includes templates provided by content providers 170. Templates may relate to a culture, a religion, a sport, a hobby, an artists, a geographic location, etc.

Next, in step 720, user 116 can select music to be associated with the interactive memorial. Like templates, such music can also be provided by content providers 170. Memorial center 110 may include a library of music that can be used with an interactive memorial.

Next, in step 725, user 116 can upload media, such as photos and movies. In one example, the interactive memorial includes a digital library where user 116, as well as guests, can upload photos and movies to share. Typically, such photos and movies either include or are associated with the recently deceased person.

Next, in step 730, user 116 provides a narrative or additional writings describing the deceased. In one example, the narrative is a previously written obituary that user 116 has the option of editing.

Next, in step 735, user 116 can modify one or more appearance parameters. For example, user 116 may select a template, and then choose to change the background, border, color scheme, font, etc.

Next, in step 740, user 116 can modify one or more options. For example, user 116 can choose to have a publicly accessible media library where guests can upload content, or user 116 can choose to have the library view or read only. Further, user 116 can also choose to have a public or private guestbook. Further, user 116 can configure whether music plays at all, or which music plays on which pages of the interactive memorial.

Next, in step 745, user 116 can configure access to the interactive memorial. For example, user 116 can choose to password protect the interactive memorial, or to share it publicly. Further, user 116 can provide a list of names or email addresses that are permitted to add/modify content, while others can only view the content of the interactive memorial. Additionally, user 116 can choose to keep certain pages private, such as a family tree, a timeline, an address book, a guestbook, etc.

Next, in step 750, user 116 can send invitations to friends and family to view the interactive memorial. For example, memorial center 110 may allow user 116 to provide email address, and memorial center 110 can send an email invitation to each address with a link to the interactive memorial. Following step 750, process 700 ends.

### Conclusion

Computing devices, such as those mentioned above, may employ any of a number of known computer operating systems. For example, such devices may use any known versions and/or varieties of the Microsoft Windows operating system; the UNIX operating system (e.g., the Solaris operating system distributed by Sun Microsystems of Menlo Park, Calif.); the AIX UNIX operating system distributed by International Business Machines of Armonk, N.Y.; and the Linux operating system. Computing devices may include any one of a number of computing devices that are known, including, without limitation, a computer workstation, a desktop, notebook, laptop, handheld computer, or some other computing device.

Computing devices generally include instructions executable by one or more computing devices such as those listed above. Computer-executable instructions may be compiled or interpreted from computer programs created using a variety of programming languages and/or technologies known to those skilled in the art, including, without limitation, and either alone or in combination, Java, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media and volatile media. Non-volatile media includes, for example, optical or magnetic disks and other persistent memory. Volatile media includes dynamic random access memory (DRAM), which typically constitutes a main memory. Common forms of computer-readable media include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for illustrating certain embodiments, and should in no way be construed to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

I claim:

1. A method, comprising:
receiving a notification that includes identification information;
authenticating the identification information contained in the notification, thereby creating authenticated data;
receiving a request to provide the authenticated data to a designee; and
providing the authenticated data to the designee.

2. The method of claim 1, wherein the notification is received from a media agency or a funeral home, and the identification information includes data about a recently deceased person, including a name, a date of birth, and a date of death.

3. The method of claim 1, wherein authenticating the identification information includes requesting a copy of an authenticating document, and storing a digital copy of the authenticating document in a database.

4. The method of claim 1, wherein the designee is one of a media agency, a funeral home, and a social networking group.

5. The method of claim 1, further comprising providing an authenticating document to the designee.

6. The method of claim 1, further comprising facilitating a user to create an interactive memorial in honor of a person identified in the notification.

7. The method of claim 6, further comprising publishing the interactive memorial.

8. The method of claim 1, further comprising receiving an obituary concerning a person identified in the notification.

9. The method of claim 1, further comprising receiving a request to create an interactive memorial, and retrieving the authenticated data in response to the request.

10. A method, comprising:
receiving a request to create an interactive memorial, wherein the request includes identification data;
determining if a database includes a record matching the received identification data;
if no match is found, requesting additional information, and authenticating the received additional information, thereby creating authenticated identification data;
if a match is found, providing the record, where the record includes authenticated identification data; and
facilitating the creation of the interactive memorial, wherein the interactive memorial includes authenticated identification data.

11. The method of claim 10, further comprising receiving authenticated identification data from a media agency or a funeral home.

12. The method of claim 10, further comprising providing the authenticated identification data to a media agency or a funeral home.

13. The method of claim 10, wherein the identification data is received from one of a user, a media agency, and a funeral home, and the identification data includes data about a recently deceased person.

14. The method of claim 10, wherein authenticating the identification data includes requesting a copy of an authenticating document, and storing a digital copy of the authenticating document in a database.

15. The method of claim 10, further comprising providing an authenticating document to a designee.

16. The method of claim 10, further comprising assisting a user to create an interactive memorial in honor of a person identified in the identification data.

17. The method of claim 10, further comprising publishing the interactive memorial.

18. A system, comprising:
a memorial center configured to facilitate the creation of an interactive memorial;
a media agency configured to send authenticated identification data to, and receive authenticated identification data from, the memorial center; and
a content provider that provides content that can be used in the interactive memorial.

19. The system of claim 1, further comprising a donee, and a financial institution, wherein the memorial center is further configured to facilitate a funds transfer between a user and a donee through the financial institution.

20. The system of claim 1, further comprising a social networking group configured to link to and from the interactive memorial.
